(19) United States
(12) Patent Application Publication
(10) Pub. No.: US 2014/0253630 A1
(43) Pub. Date: Sep. 11, 2014

(54) INK-JET RECORDING APPARATUS

(71) Applicant: Brother Kogyo Kabushiki Kaisha, Nagoya-shi (JP)

(72) Inventors: Yutaka KAKIGAHARA, Kariya-shi (JP); Shigeki MURAKI, Yokkaichi-shi (JP)

(73) Assignee: BROTHER KOGYO KABUSHIKI KAISHA, Nagoya-shi (JP)

(21) Appl. No.: 14/286,752

(22) Filed: May 23, 2014

Related U.S. Application Data
(63) Continuation of application No. 12/721,773, filed on Mar. 11, 2010.

(30) Foreign Application Priority Data
Mar. 11, 2009 (JP) 2009-057235

(51) Int. Cl. B41J 2/01

(52) U.S. Cl. CPC B41J 2/01
USPC 347/20

(57) ABSTRACT

An ink-jet recording apparatus including a position adjusting mechanism of a recording head, including: a first force applying member that applies a force, in a first direction, to a first side face of the recording head; a first position adjusting member that holds the recording head by receiving the force in the first direction at a first inclined face thereof inclined with respect to the first direction; a first pressing member disposed between the first inclined face and a second side face of the recording head and having a second inclined face which is parallel to the first inclined face and which contacts the first inclined face, and a pressing face which presses the second side face; and a first moving mechanism that moves the first position adjusting member relative to the first pressing member in a direction along a second direction.

### CROSS REFERENCE TO RELATED APPLICATION

The present application claims priority from Japanese Patent Application No. 2009-057235, which was filed on Mar. 11, 2009, the disclosure of which is herein incorporated by reference in its entirety.

### BACKGROUND OF THE INVENTION

1. Field of the Invention

The present invention relates to an ink-jet recording apparatus including a head position adjusting mechanism configured to adjust a position of a recording head.

2. Description of the Related Art

In an ink-jet recording apparatus such as an ink-jet printer, a recording head for ejecting ink onto a recording medium such as a paper sheet is provided on a main body so as to be attached and detached. In this construction, it is required to mount the recording head at an appropriate position in order to form an image having a high quality on the recording medium.

In a conventional technique, there is a recording head position adjusting structure in which a cylindrical tubular member moved upward and downward by a thread shaft portion is disposed between a side end portion of a recording head mounted on a head holder and an inclined block supported by the head holder and having an inclined face inclined at an inclination angle θ. In the recording head position adjusting structure, the side end portion of the recording head is displaced in a direction toward or away from the inclined block by the upward or downward movement of the tubular member, thereby adjusting a position of the recording head.

### SUMMARY OF THE INVENTION

However, in the case of the structure in which the tubular member is moved upward and downward between the recording head and the inclined face like the conventional technique, the tubular member is moved not only in an adjusting direction but also in a direction perpendicular to the adjusting direction. Thus, the tubular member is rubbed with the recording head and also with the inclined face. As a result, wear occurs in the tubular member and the recording head, making it impossible to perform a positional adjustment with high accuracy.

This invention has been developed in view of the above-described situation, and it is an object of the present invention to provide an ink-jet recording apparatus including a head position adjusting mechanism capable of performing a positional adjustment of a recording head minutely and with high accuracy.

The object indicated above may be achieved according to the present invention which provides an ink-jet recording apparatus including a position adjusting mechanism of a recording head supported by a support member, the ink-jet recording apparatus comprising: a first force applying member configured to apply a force, in a first direction extending along the recording surface, to a first side face which is one of a plurality of side faces of the recording head having a recording surface that faces a recording medium upon forming an image on the recording medium, the first side face intersecting the recording surface; a first position adjusting member supported by the support member and configured to hold the recording head by receiving the force in the first direction which is applied to the first side face by the first force applying member, the first position adjusting member having, at a portion thereof which receives the force in the first direction, a first inclined face inclined with respect to the first direction; a first pressing member disposed between the first inclined face and a second side face which is one of the plurality of side faces that is opposed to the first side face, the first pressing member having (i) a second inclined face which is an inclined face parallel to the first inclined face and which contacts the first inclined face and (ii) a pressing face which presses the second side face; and a first moving mechanism configured to move the first position adjusting member relative to the first pressing member in a direction along a second direction intersecting both of the first direction and an in-plane direction of the first inclined face.

### BRIEF DESCRIPTION OF THE DRAWINGS

The objects, features, advantages, and technical and industrial significance of the present invention will be better understood by reading the following detailed description of an embodiment of the invention, when considered in connection with the accompanying drawings, in which:

FIG. 1 is a side view generally showing an internal structure of an ink-jet printer including a head position adjusting mechanism, as an embodiment of the present invention;

FIG. 2A is a plan view of the head position adjusting mechanism, and FIG. 2B is a side view thereof;

FIGS. 3A, 3B, and 3C are enlarged views each showing a principal part B in FIG. 2B;

FIGS. 4A, 4B, and 4C are views for explaining a construction of a head position adjusting mechanism;

FIG. 5A is a plan view of a head position adjusting mechanism in an modification of the present invention, FIG. 5B is a side view thereof, FIG. 5C is a plan view of a head position adjusting mechanism in another modification of the present invention, and FIG. 5D is a side view thereof; and

FIG. 6 is a cross-sectional view taken along line V-V of FIG. 2B.

### DESCRIPTION OF THE EMBODIMENT

Hereinafter, there will be described embodiment of the present invention by reference to the drawings.

<Mechanical Construction of Ink-Jet Printer>

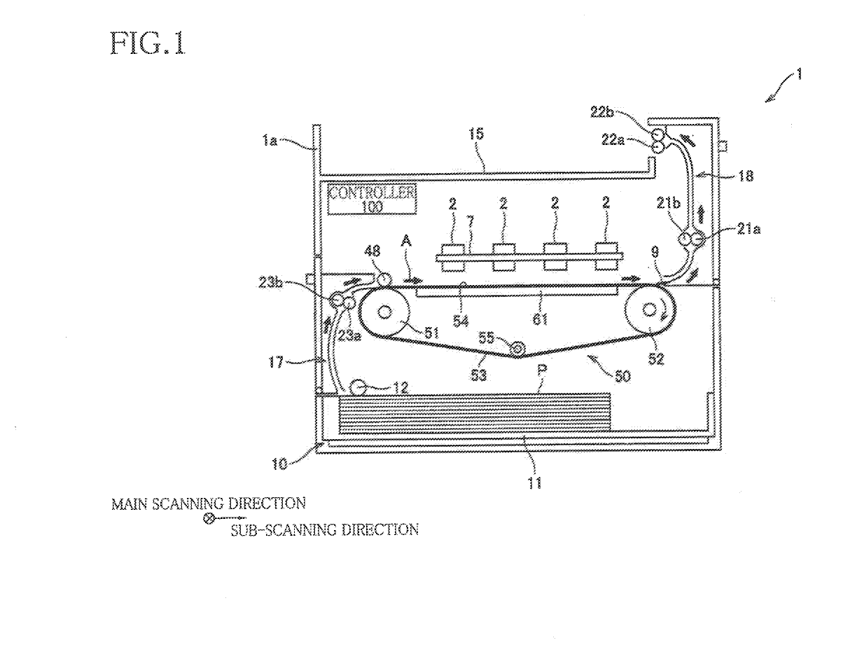

As shown in FIG. 1, an ink-jet printer (i.e., an ink-jet recording apparatus) 1 as an embodiment of the present invention is a color ink-jet printer including (a) a casing la having a rectangular parallelepiped shape and (b) four ink-jet heads (i.e., recording heads) 2 disposed in the casing 1a and configured to respectively eject inks of four colors, namely, magenta, cyan, yellow, and black. In this ink-jet printer 1, a sheet-supply device 10 is disposed in a lower portion of the printer 1 in FIG. 1 while a sheet-discharge portion 15 is disposed in an upper portion of the printer 1 in FIG. 1. Between the sheet-supply device 10 and the sheet-discharge portion 15 is provided a sheet-feed mechanism 50 which feeds a sheet (i.e., a recording medium) P in a sheet-feed direction A. Further, the ink-jet printer 1 includes a controller 100 configured to control these operations.

Each of the four ink-jet heads 2 has a generally rectangular parallelepiped shape elongated in a main scanning direction. The four ink-jet heads 2 are fixed to a frame (i.e., a support member) 7 and arranged so as to be adjacent to each other in a sub-scanning direction. That is, this printer 1 is a printer of line type. It is noted that, in the present embodiment, the sub-scanning direction is a direction parallel to the sheet-feed direction A while the main scanning direction is a direction perpendicular to the sub-scanning direction and parallel to a horizontal surface (i.e., a direction perpendicular to a sheet surface of FIG. 1).

Each of the ink-jet heads 2 includes a stacked body, not shown, constituted by adhering (a) a channel unit in which are formed ink channels respectively having pressure chambers and (b) actuators which respectively apply pressures to the ink in the pressure chambers. A bottom surface of each ink-jet head 2 functions as an ink-ejection surface (i.e., a recording surface) 2a from which the ink is ejected.

The sheet-supply device 10 includes (a) a sheet-supply cassette 11 capable of accommodating a plurality of the sheets P in a state in which the sheets P are stacked on each other, (b) a sheet-supply roller 12 which supplies each sheet P from the sheet-supply cassette 11, and (c) a sheet-supply motor, not shown, which rotates the sheet-supply roller 12. The sheet-supply cassette 11 is disposed so as to be inserted and removed in the direction perpendicular to the sheet surface of FIG. 1. When mounted on the casing 1a, the sheet-supply cassette 11 is disposed at a position overlapping with the sheet-feed mechanism 50 in an upward and downward direction in FIG. 1. The sheet-supply roller 12 contacts an uppermost one of the sheets P while rotating, and thereby supplies the uppermost sheet P from the sheet-supply cassette 11. It is noted that the sheet-supply motor which rotates the sheet-supply roller 12 is controlled by the controller 100.

Between the sheet-supply cassette 11 and the sheet-feed mechanism 50 along a sheet-feed path in a left end portion of the printer 1 in FIG. 1, there are disposed (a) a sheet-supply guide 17 curving and extending from the sheet-supply cassette 11 to the sheet-feed mechanism 50 and (b) two sheet-feed rollers 23a, 23b disposed on a downstream portion of the sheet-supply guide 17. The sheet-feed roller 23b is driven to be rotated by a sheet-feed motor, not shown, controlled by the controller 100. Further, the sheet-feed roller 23a is a driven roller rotated with the feeding of the sheet P.

In this structure, the controller 100 controls the sheet-supply roller 12 such that the roller 12 rotates in a clockwise direction in FIG. 1, whereby the sheet P contacting the sheet-supply roller 12 is fed through the sheet-supply guide 17 toward an upper portion of the printer 1 in FIG. 1. Then, the sheet P is supplied to the sheet-feed mechanism 50 while being nipped by the sheet-feed rollers 23a, 23b.

The sheet-feed mechanism 50 includes (a) two belt rollers 51, 52, (b) an endless sheet-feed belt (i.e., a sheet-feed member) 53 wound around the two belt rollers 51, 52 so as to bridge the belt rollers 51, 52, (c) a tension roller 55 which applies tension to the sheet-feed belt 53, (d) a sheet-feed motor, not shown, which rotates the belt roller 52, and (e) a platen 61 having a generally rectangular parallelepiped shape. The two belt rollers 51, 52 are disposed side by side in the sheet-feed direction A. The sheet-feed belt 53 has, on a surface thereof, a sheet-feed surface (i.e., an outer surface) 54 which supports the sheet P thereon.

The belt roller 52 is a drive roller rotated by the sheet-feed motor, not shown, in the clockwise direction in FIG. 1. The belt roller 51 is a driven roller rotated in the clockwise direction in FIG. 1 with rotation of the sheet-feed belt 53 by the rotation of the belt roller 52. Further, the tension roller 55 is rotatably supported by the casing 1a in a state in which the tension roller 55 applies tension to the sheet-feed belt 53 while contacting an inner surface of a lower portion of the sheet-feed belt 53. The tension roller 55 is rotated in the clockwise direction in FIG. 1 with the rotation of the sheet-feed belt 53. The platen 61 is formed to have a length slightly longer than that of each of the sheets P and the sheet-feed belt 53 in the main scanning direction.

Further, an upper surface of the platen 61 contacts an inner surface of an upper portion of the sheet-feed belt 53 and thereby supports the sheet-feed belt 53 from the inner surface thereof. Thus, the sheet-feed surface 54 of the upper portion of the sheet-feed belt 53 and the respective ink-ejection surfaces 2a of the ink-jet heads 2 are parallel to each other while facing each other, and a small space is formed between the ink-ejection surfaces 2a and the sheet-feed surface 54 of the sheet-feed belt 53. This space partly constitutes the sheet-feed path.

A pressing roller 48 is disposed on an upstream side of one of the ink-jet heads 2 which is disposed at the most upstream side in the sheet-feed direction A among the four ink-jet heads 2 and at a position facing the belt roller 51. The pressing roller 48 is biased or forced to the sheet-feed surface 54 by an elastic material such as a spring, not shown, and presses onto the sheet-feed surface 54 the sheet P supplied from the sheet-supply device 10. Further, the pressing roller 48 is a driven roller rotated with the rotation of the sheet-feed belt 53.

In this construction, the sheet-feed belt 53 is rotated by the control of the controller 100 in which the belt roller 52 is rotated in the clockwise direction in FIG. 1. In this time, the belt roller 51, the tension roller 55, and the pressing roller 48 are also rotated with the rotation of the sheet-feed belt 53. As a result, the sheet P supplied from the sheet-supply device 10 is fed in the sheet-feed direction A. Further, in this time, when the sheet P fed while being held on the sheet-feed surface 54 of the sheet-feed belt 53 passes through just below the four ink-jet heads 2, the controller 100 controls each ink-jet head 2 such that the inks of the four colors are ejected onto the sheet P. As a result, a desired color image is formed on the sheet P.

As shown in FIG. 1, a peeling plate 9 is provided just on a downstream side of the sheet-feed mechanism 50 in the sheet-feed direction A. The peeling plate 9 peels the sheet P from the sheet-feed surface 54 by entering of a distal end of the peeling plate 9 into a position between the sheet P and the sheet-feed belt 53.

Between the sheet-feed mechanism 50 and the sheet-discharge portion 15 along the sheet-feed path, there are disposed (a) four sheet-feed rollers 21a, 21b, 22a, 22b and (b) a sheet-discharge guide 18 disposed between the sheet-feed rollers 21a, 21b and the sheet-feed rollers 22a, 22b. The sheet-feed rollers 21b, 22b are driven to be rotated by a sheet-feed motor, not shown, controlled by the controller 100. Further, the sheet-feed rollers 21a, 22a are driven rollers rotated with the feeding of the sheet P.

In this construction, the controller 100 causes the sheet-feed motor to be driven such that the sheet-feed rollers 21b, 22b are rotated, whereby the sheet P fed by the sheet-feed mechanism 50 is fed through the sheet-discharge guide 18 toward an upper portion of the printer 1 in FIG. 1 while being held by the sheet-feed rollers 21a, 21b. Then, the sheet P is discharged to the sheet-discharge portion 15 while being held by the sheet-feed rollers 22a, 22b.

<Mechanical Construction of Head Position Adjusting Mechanism)

There will be next explained a head position adjusting mechanism 30 which adjusts a position of each ink-jet head 2.

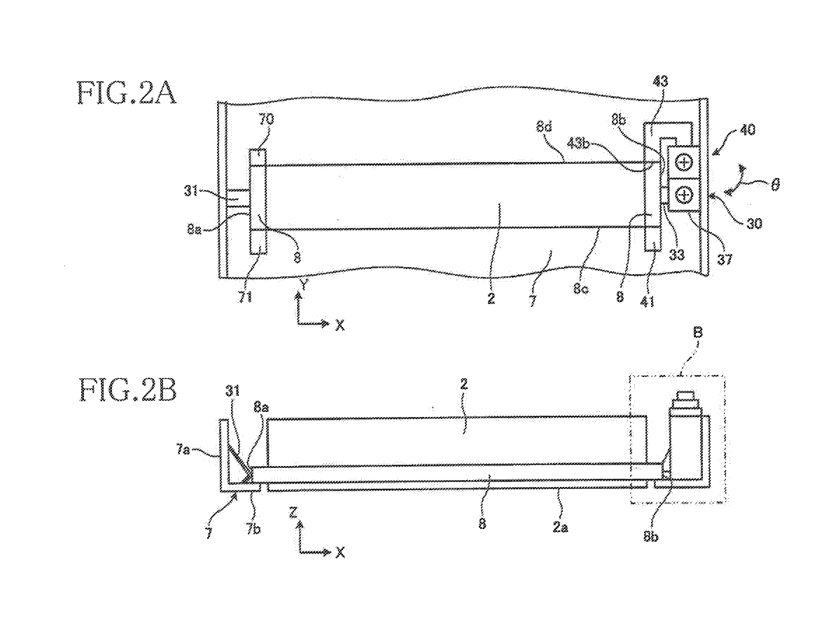

Each ink-jet head 2 is fixed to the frame 7 as described above and, as shown in FIGS. 2A and 2B, has a stacked body constituted by stacked plates including a plate 8 having the same width as the other plates and a slightly larger length than the other plates. The ink-jet head 2 has the ink-ejection surface 2a as shown in a lower portion in FIG. 2B. As shown in FIG. 2A, the head position adjusting mechanism 30 for adjusting the position of each ink-jet head 2 is provided on the frame 7 for each head 2. It is noted that, in FIG. 2B, the plates in the ink-jet head 2 other than the plate 8 are shown so as not to be distinguished from each other. It is further noted that the plate 8 can be considered to be formed integrally with the ink-jet head 2. Thus, pressing the plate 8 can be considered to pressing the ink-jet head 2. More specifically, pressing each side face of the plate 8 can be considered to pressing a corresponding side face of the ink-jet head 2.

As shown in FIGS. 2A and 2B, the head position adjusting mechanism 30 includes a plate spring 31 as a first force applying member which biases or forces, in a +X direction as a first direction, a first side face 8a of the plate 8 which intersects the ink-ejection surface 2a. As shown in FIG. 2B, the plate spring 31 has an elbowed shape and is fixed at one end thereof to a side wall 7a of the frame 7 and at the other end thereof to a bottom wall 7b of the frame 7. A bent portion of the plate spring 31 is held in contact with the first side face 8a. Further, the plate spring 31 is always kept contracted so as to always keep biasing or forcing the first side face 8a in the +X direction.

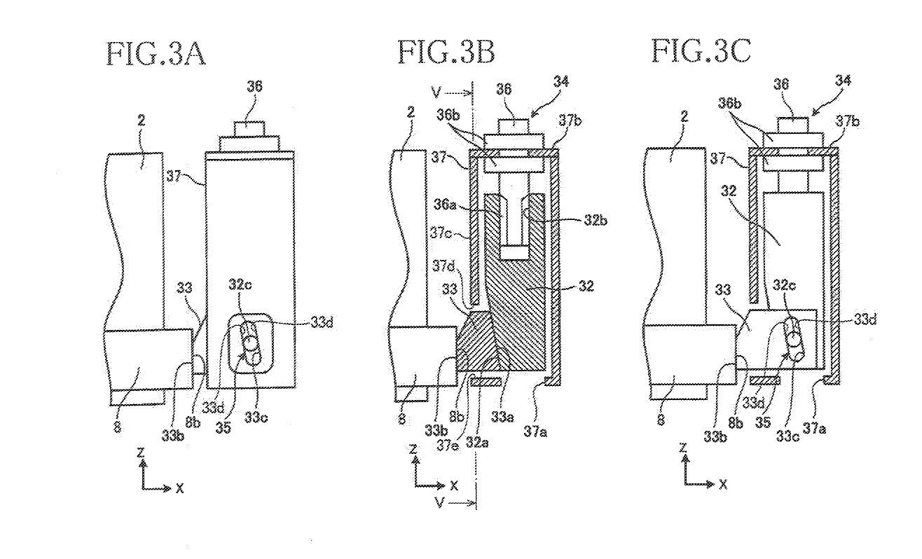

Further, the head position adjusting mechanism 30 includes a first position adjusting member 32 as shown in FIG. 3B which is a partial cross-sectional view of FIG. 3A. The first position adjusting member 32 supported by the frame 7 via a bolt 36 and a first restricting member 37 which will be described below has a prismatic shape and holds the ink-jet head 2 by receiving the force in the +X direction which is applied by the plate spring 31. The first position adjusting member 32 has a first inclined face 32a at a lower portion thereof. The first inclined face 32a is inclined with respect to the +X direction such that a thickness of the first position adjusting member 32 in the +X direction becomes smaller from an upper portion toward a lower portion in FIG. 3B. That is, the first inclined face 32a is formed to be a face inclined with respect to ±X directions (i.e., a direction along the +X direction). This means that the first inclined face 32a is not a vertical or parallel face with respect to the ±X directions. Further, in the present embodiment, the first inclined face 32a is formed to be a face parallel to a Y axis.

An angle of the inclination of the first inclined face 32a of the first position adjusting member 32 and a width of the first inclined face 32a in an upward and downward direction in FIG. 3B are set in accordance with a moving amount by which a first pressing member 33 described below is moved in the ±X directions. That is, where the angle of the inclination of the first inclined face 32a is low, that is, where an angle of the first inclined face 32a with respect to a Z axis direction which is the upward and downward direction in FIG. 3B is small, the moving amount by which the first pressing member 33 is moved in the ±X directions becomes small, while where the angle of the inclination of the first inclined face 32a is high, that is, where the angle of the first inclined face 32a with respect to the Z axis direction is large, the moving amount by which the first pressing member 33 is moved in the ±X directions becomes large. Further, in the case where the angle of the inclination of the first inclined face 32a is fixed, where the width of the first inclined face 32a in the upward and downward direction in FIG. 3B is small, the moving amount by which the first pressing member 33 is moved in the ±X directions becomes small, while the width of the first inclined face 32a in the upward and downward direction in FIG. 3B is large, the moving amount by which the first pressing member 33 is moved in the ±X directions becomes large.

Further, as shown in FIG. 3B, the head position adjusting mechanism 30 includes the first pressing member 33. The first pressing member 33 is disposed between (a) a second side face 8b of the plate 8 facing in a direction opposite to a direction in which the first side face 8a of the plate 8 faces, that is, the second side face 8b is opposite to the first side face 8a and (b) the first inclined face 32a of the first position adjusting member 32, and has (a) a contacting face 33a as a second inclined face which is parallel to the first inclined face 32a and contacts the first inclined face 32a and (b) a pressing face 33b which presses the second side face 8b. The contacting face 33a is made parallel with the first inclined face 32a, thereby being held in surface contact with the first inclined face 32a. An entire area of the pressing face 33b is a flat face which is held in surface contact with the second side face 8b.

Further, as shown in FIG. 3B, the head position adjusting mechanism 30 includes an adjusting mechanism 34 as a first moving mechanism which moves the first position adjusting member 32 in ±Z directions (i.e., a direction along a second direction) intersecting the ±X directions and an in-plane direction of the first inclined face 32a. The adjusting mechanism 34 includes (a) a thread hole 32b as a first thread member formed in an upper portion of the first position adjusting member 32 in the ±Z directions, (b) the bolt 36 having, at a lower portion thereof, a thread 36a as a second thread member engaged with the thread hole 32b, and (c) the first restricting member 37 which is supported by the frame 7 and which restricts the movement of the bolt 36 in the ±Z directions and further restricts the direction of the movement of the first pressing member 33 substantially to the ±X directions.

A pair of flanges 36b are provided on an upper portion of the bolt 36. The first restricting member 37 having a square cylindrical shape is provided on the frame 7 and restricts rotation of the first position adjusting member 32 by surrounding the first position adjusting member 32 having the prismatic shape. Further, the first restricting member 37 has an opening 37a at a lower portion thereof such that the first position adjusting member 32 is movable in a −Z direction, passing an end portion of the first restricting member 37 in the −Z direction. Further, the first restricting member 37 includes, at an upper portion thereof, a top plate 37b as a limiting member sandwiched between the pair of flanges 36b and having a hole through which the bolt 36 passes through.

Further, as shown in FIG. 3B, the first restricting member 37 has an opening formed in a side face 37c as one of side faces of the first restricting member 37 which is nearer to the ink-jet head 2 (that is, a side face located on a −X directional side). The first pressing member 33 can be inserted into or enter the first restricting member 37 through this opening. An upper end of the opening is defined by an upper end portion 37d as a second-direction restricting portion or a first contact portion while a lower end of the opening is defined by a lower end portion 37e also as the second-direction restricting portion or a second contact portion. The upper end portion 37d contacts an upper end portion of the first pressing member 33 while the lower end portion 37e contacts a lower end portion of the first pressing member 33. As shown in FIG. 3B, a space or distance between the upper end portion 37d and the lower end portion 37e in the Z axis direction is made slightly larger than a width of a portion of the first pressing member 33 in the ±Z directions, the portion being inserted into the first restricting member 37. That is, there is formed a minimum necessary clearance such that the first pressing member 33 can be smoothly moved when the first position adjusting member 32 is moved in the ±Z directions and thereby the first pressing member 33 is moved in the ±X directions. In the case where the clearance is formed between the first pressing member 33 and the upper end portion 37d or between the first pressing member 33 and the lower end portion 37e, when the first position adjusting member 32 is moved in the ±Z directions, the first pressing member 33 is moved together with the first position adjusting member 32 slightly in the ±Z directions. Then, the first pressing member 33 is brought into contact with the upper end portion 37d or the lower end portion 37e, thereby restricting the further movement of the first pressing member 33 in the ±Z directions. Then, where the first position adjusting member 32 is further moved in the ±Z directions, the first pressing member 33 is not moved in the ±Z directions but moved only in the ±X directions. In the present embodiment, as described above, the movements of the first pressing member 33 in the ±Z directions by the clearance between the first pressing member 33 and the upper end portion 37d or the lower end portion 37e and then in the ±X directions are defined as the movement of the first pressing member 33 substantially only in the ±X directions.

Further, as described above, since each of the first inclined face 32a and the contacting face 33a is a face parallel to the Y axis, the first pressing member 33 is not moved in ±Y directions when the first pressing member 33 is moved by the movement of the first position adjusting member 32 in the ±Z directions. Thus, it can be said that the first pressing member 33 in the present embodiment is moved substantially only in the ±X directions.

Further, as shown in FIG. 3C which is a partial cross-sectional view of FIG. 3A, the head position adjusting mechanism 30 includes a first engaging mechanism 35 which engages the first position adjusting member 32 and the first pressing member 33 with each other such that contacting face 33a is held in contact with the first inclined face 32a when the first position adjusting member 32 is moved in the ±Z directions. The first engaging mechanism 35 includes a slit 33c formed in the first pressing member 33 and a pin 32c provided on the first position adjusting member 32. The slit 33c is defined by a pair of slit walls 33d of the first pressing member 33 which are provided so as to extend in parallel with the first inclined face 32a, that is, so as to be parallel to each other and extend in parallel with the first inclined face 32a. The pin 32c is fitted into the slit 33c so as to be movable in the slit 33c while contacting the slit walls 33d.

A length of the slit 33c is set in accordance with a moving amount by which the first pressing member 33 is moved in the ±X directions. That is, where the length of the slit 33c is small, the moving amount by which the first pressing member 33 is moved in the ±X directions becomes small, while where the length of the slit 33c is large, the moving amount by which the first pressing member 33 is moved in the ±X directions becomes large. The first inclined face 32a and the contacting face 33a are provided so as to contact each other within a range of the movement of the first pressing member 33 which is defined by the length of the slit 33c.

In this construction, when an amount in which the thread 36a of the bolt 36 and the thread hole 32b of the first position adjusting member 32 are engaged with each other has been adjusted by the rotation of the bolt 36, only the first position adjusting member 32 is moved upward and downward in the ±Z directions in FIG. 3B because the movement of the bolt 36 in the ±Z directions is limited by the engagement of the pair of flanges 36b and the top plate 37b. Specifically, where the amount in which the thread 36a and the thread hole 32b are engaged with each other is reduced, the first position adjusting member 32 is moved in the −Z direction, while where the amount in which the thread 36a and the thread hole 32b are engaged with each other is increased, the first position adjusting member 32 is moved in a +Z direction. In this time, the first position adjusting member 32 is engaged with the first pressing member 33 by the first engaging mechanism 35 and surrounded with the first restricting member 37 having the square cylindrical shape, whereby the rotation of the first position adjusting member 32 is restricted. In other words, the first restricting member 37 restricts the movement of the first position adjusting member 32 such that the first position adjusting member 32 is not rotated by the rotational operation given to the adjusting mechanism 34. As thus described, the adjusting mechanism 34 moves the first position adjusting member 32 in the ±Z directions, thereby adjusting the position of the first position adjusting member 32. That is, the adjusting mechanism 34 converts a rotational operation given to the adjusting mechanism 34 to a moving operation of the first position adjusting member 32 in the ±Z directions.

Further, the first pressing member 33 having the contacting face 33a held in contact with the first inclined face 32a is moved in the ±X directions in accordance with the movement of the first position adjusting member 32 in the ±Z directions. Specifically, where the first position adjusting member 32 is moved in the −Z direction, the position of the first inclined face 32a contacting the contacting face 33a is relatively moved upward, and then the first pressing member 33 is pressed by the first position adjusting member 32 to be moved in a −X direction because the thickness of the first position adjusting member 32 becomes gradually larger. On the other hand, where the first position adjusting member 32 is moved in the +Z direction, the position of the first inclined face 32a contacting the contacting face 33a is relatively moved downward, and then the first pressing member 33 is pressed by the plate spring 31 to be moved in the +X direction because the thickness of the first position adjusting member 32 becomes gradually smaller. In this time, the pin 32c provided on the first position adjusting member 32 is moved in the slit 33c of the first pressing member 33. The movement of the first pressing member 33 in the ±X directions causes the plate 8 forced by the plate spring 31 in the +X direction and pressed by the first pressing member 33 in the −X direction to be moved in the ±X directions. As a result, the position of the ink-jet head 2 is adjusted in the ±X directions.

In this state, although the first pressing member 33 presses the second side face 8b, a relative movement of the first pressing member 33 and the plate 8 in the ±Z directions is not caused, so that wear caused by a rub between the first pressing member 33 and the second side face 8b does not occur in the first pressing member 33 and the second side face 8b, thereby making it possible to adjust the position of the ink-jet head 2 with relatively high accuracy. Further, the slit 33c formed in the first pressing member 33 and the pin 32c provided on the first position adjusting member 32 are engaged with each other, whereby the contact of the first inclined face 32a of the first position adjusting member 32 and the contacting face 33a of the first pressing member 33 is maintained. Thus, since the plate spring 31 requires only a force for pressing the second side face 8b to the pressing face 33b of the first pressing member 33, a fine positional adjustment can be easily performed by making it possible to move the first position adjusting member 32 with a relatively small force by making a force of the plate spring 31 smaller. As a result, the adjustment of the position of each ink-jet head 2 can be performed minutely and with relatively high accuracy.

Further, the first inclined face 32a of the first position adjusting member 32 extends in a direction inclined with respect to an X axis, and thus when the first position adjusting member 32 is moved in the ±Z directions, the first pressing member 33 can be moved in the ±X directions. In the present embodiment, the first restricting member 37 restricts the direction of the movement of the first pressing member 33 substantially only to the ±X directions, thereby making it possible not to move the first pressing member 33 in a direction deviating from the ±X directions.

Further, the position of the first position adjusting member 32 can be adjusted with relatively high accuracy by the adjustment of the amount in which the thread 36a of the bolt 36 whose movement in the ±Z directions is limited is engaged with the thread hole 32b.

Further, the flat face of the pressing face 33b of the first pressing member 33, which is held in surface contact with the second side face 8b is easily formed, thereby easily forming the pressing face 33b.

Returning to FIG. 2A, on the frame 7 is provided, for each ink-jet head 2, a head position adjusting mechanism 40 as a third direction adjusting mechanism configured to adjust the position of each ink-jet head 2 in a direction different from the ±X directions, in addition to the head position adjusting mechanism 30 configured to perform the positional adjustment of each ink-jet head 2 in the ±X directions.

The head position adjusting mechanism 40 has a construction similar to that of the head position adjusting mechanism 30. A plate spring 41 as a second force applying member included in the head position adjusting mechanism 40 has an elbowed shape and is fixed at one end thereof to a fixing member, not shown, and at the other end thereof to the bottom wall 7b of the frame 7. A bent portion of the plate spring 41 is held in contact with a third side face 8c of the plate 8 which intersects or is perpendicular to the first side face 8a and the second side face 8b. The third side face 8c has a length larger in a direction along the ink-ejection surface 2a than that of the first side face 8a. Further, the plate spring 41 is always kept contracted so as to always keep biasing or forcing a second-side-face-side portion of the third side face 8c in a +Y direction as a third direction, the second-side-face-side portion being nearer to the second side face 8b. On the other hand, a three-sided second pressing member 43 included in the head position adjusting mechanism 40 contacts at one end portion thereof a fourth side face 8d of the plate 8, thereby pressing, in a −Y direction, the fourth side face 8d that intersects the first side face 8a and the second side face 8b and that faces in a direction opposite to a direction in which the third side face 8c faces, that is, the fourth side face 8d of the plate 8 which is opposite to the third side face 8c. More specifically, the head position adjusting mechanism 40 adjusts a position of a second-side-face near contact portion of the fourth side face 8d in the ±Y directions by contacting the second-side-face near contact portion which corresponds to the second-side-face-side portion.

Further, in a left portion in FIG. 2A, a fixed reference member 70 fixed to the frame 7 is provided. Further, on the frame 7 is provided a plate spring 71 also as the second force applying member which presses the plate 8 to the fixed reference member 70. The plate spring 71 has an elbowed shape and is fixed at one end thereof to a fixing member, not shown, and at the other end thereof to the bottom wall 7b of the frame 7. A bent portion of the plate spring 71 is held in contact with the third side face 8c. Further, the plate spring 71 is always kept contracted so as to always keep biasing or forcing a first-side-face-side portion of the third side face 8c in the +Y direction, the first-side-face-side portion being nearer to the first side face 8a. This plate spring 71 causes a left end of the fourth side face 8d of the plate 8 to be always held in contact with the fixed reference member 70, the left end corresponding to the first-side-face-side portion.

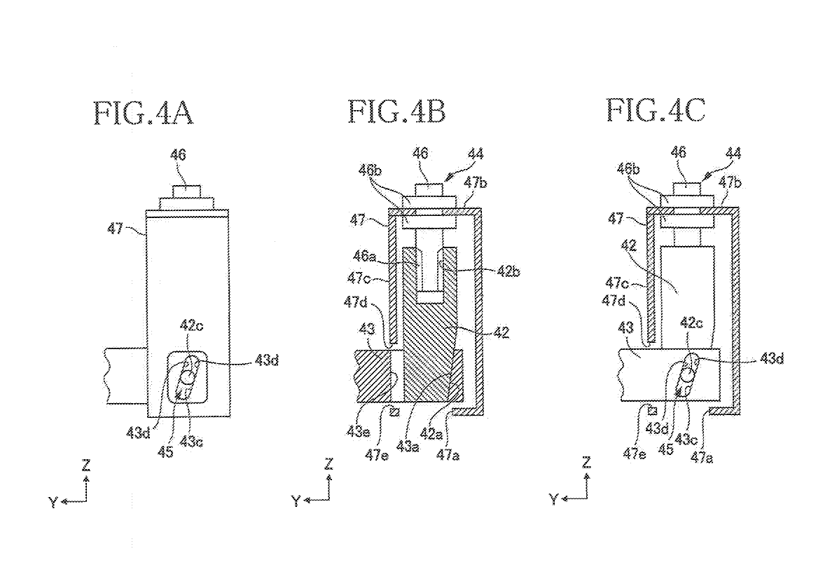

Here, there will be explained a construction of the head position adjusting mechanism 40 with reference to FIGS. 4A, 4B, and 4C. FIG. 4A is a view of the head position adjusting mechanism 40 as seen in the +X direction, FIG. 4B is a partial cross-sectional view of the head position adjusting mechanism 40 shown in FIG. 4A, and FIG. 4C is partial cross-sectional view showing an internal construction of the head position adjusting mechanism 40 shown in FIG. 4A. It is noted that, in FIGS. 4A, 4B, and 4C, a portion of the second pressing member 43 which contacts the fourth side face 8d of the plate 8 is omitted. The head position adjusting mechanism 40 includes a second position adjusting member 42 as shown in FIG. 4B. The second position adjusting member 42 supported by the frame 7 via a bolt 46 and a second restricting member 47 which will be described below has a prismatic shape and holds the ink-jet head 2 by receiving the force in the +Y direction which is applied by plate spring 71. The second position adjusting member 42 has a third inclined face 42a at a lower portion thereof. The third inclined face 42a is inclined with respect to the +Y direction such that a thickness of the second position adjusting member 42 in the +Y direction becomes smaller from an upper portion toward a lower portion in FIGS. 4A, 4B, and 4C. That is, the third inclined face 42a is formed to be a face inclined with respect to the ±Y directions as a direction along the third direction. This means that the third inclined face 42a is not a vertical or parallel face with respect to the ±Y directions. Further, in the present embodiment, the third inclined face 42a is formed to be a face parallel to the X axis.

An angle of the inclination of the third inclined face 42a of the second position adjusting member 42 and a width of the third inclined face 42a in an upward and downward direction in FIGS. 4A, 4B, and 4C are set in accordance with a moving amount by which the second pressing member 43 is moved in the ±Y directions. That is, where the angle of the inclination of the third inclined face 42a is low, that is, where an angle of the third inclined face 42a with respect to the Z axis direction which is the upward and downward direction in FIGS. 4A, 4B, and 4C is small, the moving amount by which the second pressing member 43 is moved in the ±Y directions becomes small, while where the angle of the inclination of the third inclined face 42a is high, that is, where the angle of the third inclined face 42a with respect to the Z axis direction is large, the moving amount by which the second pressing member 43 is moved in the ±Y directions becomes large. Further, in the case where the angle of the inclination of the third inclined face 42a is fixed, where the width of the third inclined face 42a in the upward and downward direction in FIGS. 4A, 4B, and 4C is small, the moving amount by which the second pressing member 43 is moved in the ±Y directions becomes small, while where the width of the third inclined face 42a in the upward and downward direction in FIGS. 4A, 4B, and 4C is large, the moving amount by which the second pressing member 43 is moved in the ±Y directions becomes large.

Further, as shown in FIG. 2A, the head position adjusting mechanism 40 includes the second pressing member 43. The second pressing member 43 has a three-sided rectangular cross section as seen in the Z axis direction and is disposed such that a flat face of one end of the three-sided second pressing member 43 is held in contact with the fourth side face 8d while the other end thereof is inserted into the second restricting member 47. Further, as shown in FIG. 4B, in a portion of the second pressing member 43 which is inserted into the second restricting member 47, there is formed a through hole into which the second position adjusting member 42 is insertable. On a portion of the second pressing member 43 which functions as an inner circumferential surface defining the through hole and contacts the third inclined face 42a of the second position adjusting member 42, there is formed a fourth inclined face 43a which is a flat face parallel to the third inclined face 42a and contacts the third inclined face 42a. Further, on a portion of the second pressing member 43 which functions as the inner circumferential surface defining the through hole and which is an end portion of the second pressing member 43 in the +Y direction, there is formed a vertical face 43e which is a flat face parallel to the Z axis direction. A clearance is always formed or exists between the vertical face 43e and the second position adjusting member 42. This clearance is for preventing that the second pressing member 43, which is moved in the −Y direction when the second position adjusting member 42 is moved in the −Z direction, cannot be moved in the −Y direction. The fourth inclined face 43a of the second pressing member 43 is always held in surface contact with the third inclined face 42a by a second engaging mechanism 45 which will be described below.

Further, as shown in FIG. 4B, the head position adjusting mechanism 40 includes an adjusting mechanism 44 as a second moving mechanism which moves the second position adjusting member 42 in the ±Z directions. The adjusting mechanism 44 includes (a) a thread hole 42b formed in an upper portion of the second position adjusting member 42 in the ±Z directions (b) the bolt 46 having, at a lower portion thereof, a thread 46a engaged with the thread hole 42b, and (c) a second restricting member 47 which is supported by the frame 7 and which restricts the movement of the bolt 46 in the ±Z directions and further restricts the direction of the movement of the second pressing member 43 substantially to the ±Y directions.

A pair of flanges 46b are provided on an upper portion of the bolt 46. The second restricting member 47 having a square cylindrical shape is provided on the frame 7 and restricts rotation of the second position adjusting member 42 by surrounding the second position adjusting member 42 having the prismatic shape. Further, the second restricting member 47 has an opening 47a at a lower portion thereof such that the second position adjusting member 42 is movable in the -Z direction. Further, the second restricting member 47 includes, at an upper portion thereof, a top plate 47b sandwiched between the pair of flanges 46b and having a hole through which the bolt 46 passes through.

Further, as shown in FIG. 4B, the second restricting member 47 has an opening formed in a side face 47c which is a side face of the second restricting member 47 located on a +Y directional side. The second pressing member 43 can be inserted into or enter the second restricting member 47 through this opening. An upper end of the opening is defined by an upper end portion 47d while a lower end of the opening is defined by a lower end portion 47e. As shown in FIG. 4B, a space or distance between the upper end portion 47d and the lower end portion 47e in the Z axis direction is made slightly larger than a width of a portion of the second pressing member 43 in the ±Z directions, the portion being inserted into the second restricting member 47. That is, there is formed a minimum necessary clearance such that when the second position adjusting member 42 is moved in the ±Z directions and thereby the second pressing member 43 is moved in the ±Y directions, the second pressing member 43 can be smoothly moved. In the case where the clearance is formed between the second pressing member 43 and the upper end portion 47c or between the second pressing member 43 and the lower end portion 47e, when the second position adjusting member 42 is moved in the ±Z directions, the second pressing member 43 is brought into contact with the upper end portion 47c or the lower end portion 47e, thereby restricting the further movement of the second pressing member 43 in the ±Z directions. Then, where the second position adjusting member 42 is further moved in the ±Z directions, the second pressing member 43 is not moved in the ±Z directions but moved only in the ±Y directions. In the present embodiment, as described above, the movement of the second pressing member 43 in the ±Z directions by a distance corresponding to the clearance between the second pressing member 43 and the upper end portion 47c or the lower end portion 47e and the subsequent movement thereof in the ±Y directions are defined as the movement of the second pressing member 43 substantially only in the ±Y directions.

Further, as described above, since each of the third inclined face 42a and the fourth inclined face 43a is a face parallel to the X axis, the second pressing member 43 is not moved in the ±X directions when the second pressing member 43 is moved by the movement of the second position adjusting member 42 in the ±Z directions. Thus, it can be said that the second pressing member 43 in the present embodiment is moved substantially only in the ±Y directions.

Further, as shown in FIG. 4C, the head position adjusting mechanism 40 includes a second engaging mechanism 45 which engages the second position adjusting member 42 and the second pressing member 43 with each other. The second engaging mechanism 45 includes a slit 43c formed in the second pressing member 43 and a pin 42c provided on the second position adjusting member 42. The slit 43c is defined by a pair of slit walls 43d of the second pressing member 43 which are provided so as to extend in parallel with the fourth inclined face 43a. The pin 42c is fitted into the slit 43c so as to be movable in the slit 43c while contacting the slit wall 43d.

A length of the slit 43c is set in accordance with a moving amount by which the second pressing member 43 is moved in the ±Y directions. That is, where the length of the slit 43c is small, the moving amount by which the second pressing member 43 is moved in the ±Y directions becomes small, while where the length of the slit 43c is large, the moving amount by which the second pressing member 43 is moved in the ±Y directions becomes large. The third inclined face 42a and the fourth inclined face 43a are provided so as to contact each other within a range of the movement of the second pressing member 43 which is defined by the length of the slit 43c.

In this construction, when an amount in which the thread 46a of the bolt 46 and the thread hole 42b of the second position adjusting member 42 are engaged with each other has been adjusted by the rotation of the bolt 46, only the second position adjusting member 42 is moved upward and downward in the ±Z directions in FIGS. 4A, 4B, and 4C because the movement of the bolt 46 in the ±Z directions is limited by the engagement of the pair of flanges 46b and the top plate 47b. Specifically, where the amount in which the thread 46a and the thread hole 42b are engaged with each other is reduced, the second position adjusting member 42 is moved in the +Z direction. In this time, the second position adjusting member 42 is engaged with the second pressing member 43 by the second engaging mechanism 45 and surrounded with the second restricting member 47 having the square cylindrical shape, whereby the rotation of the second position adjusting member 42 is restricted. As thus described, the adjusting mechanism 44 moves the second position adjusting member 42 in the ±Z directions, thereby adjusting the position of the second position adjusting member 42.

In this construction, the second pressing member 43 is moved in the ±Y directions in accordance that a position adjusting member of the head position adjusting mechanism 40 is moved in the ±Z directions. Specifically, where the second position adjusting member 42 is moved in the −Z direction, the second pressing member 43 is pressed by the second position adjusting member 42, and thereby the fourth inclined face 43a of the second pressing member 43 is moved in the −Y direction and the pressing face 43b is also moved in the −Y direction, while where the second position adjusting member 42 is moved in the +Z direction, the second pressing member 43 is pressed by the plate spring 41, and thereby the fourth inclined face 43a is moved in the +Y direction and the pressing face 43b is also moved in the +Y direction. As a result, the plate 8 forced by the plate spring 41 in the +Y direction and pressed by the second pressing member 43 in the −Y direction is moved in the ±Y directions. In this time, in a left portion in FIG. 2A, since the left end of the plate 8 is held in pressing contact with the fixed reference member 70, the plate 8 is moved about a contact point of the plate 8 and the fixed reference member 70 so as to draw an arc. As a result, the position of the ink-jet head 2 is adjusted in ±θ directions.

Further, each ink-jet head 2 can be adjusted at a desired position on a XY plane by combining the head position adjusting mechanism 30 for adjusting the position of the ink-jet head 2 in the ±X directions and the head position adjusting mechanism 40 for adjusting the position of the ink-jet head 2 in the ±θ directions. Here, the XY plane is a plane defined by the ±X directions and the ±Y directions.

When the positional adjustment of the ink-jet head 2 is finished, the plate 8 is fixed to the frame 7 by a fixing means, not shown. For example, the plate 8 is fixed to the frame 7 by a thread stopper and/or a bolt stopper. As a result, the ink-jet head 2 is fixed to an appropriate position on the frame 7.

<Modification of the Present Embodiment>

While the embodiment of the present invention has been described above, it is to be understood that the invention is not limited to the details of the illustrated embodiment, but may be embodied with various changes and modifications, which may occur to those skilled in the art, without departing from the spirit and scope of the invention. Further, while the most preferable operations and effects of the present invention have been described in the illustrated embodiment, operations and effects of the present inventions are not limited to those described in the illustrated embodiment.

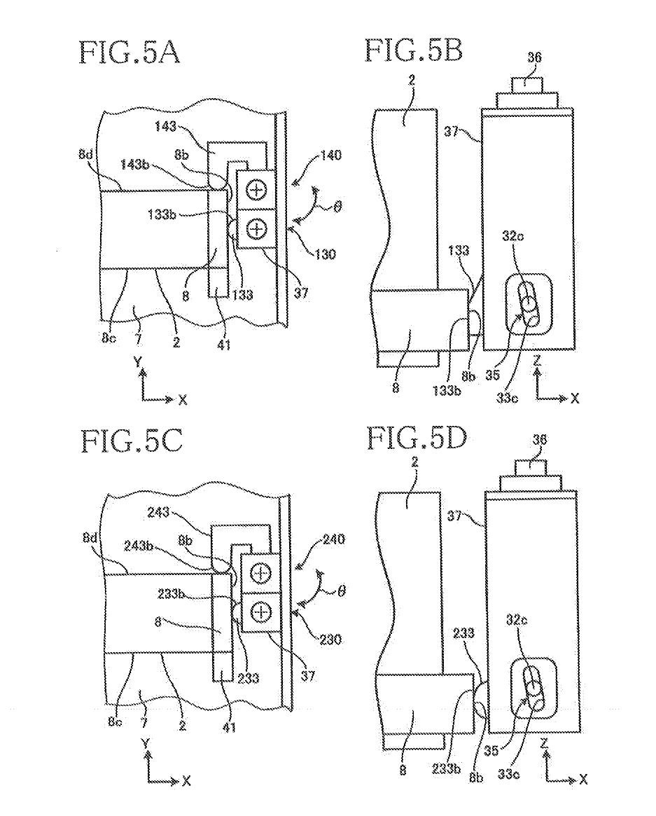

For example, in the above-described embodiment, the pressing face 33b of the first pressing member 33 of the head position adjusting mechanism 30 which adjusts the position of the ink-jet head 2 in the ±X directions has the flat face which is held in surface contact with the second side face 8b, but as shown in FIGS. 5A and 5B, a pressing face 133b of a pressing member 133 of a head position adjusting mechanism 130 which adjusts the position of the ink-jet head 2 in the ±X directions may have a curved face which is held in line contact with the second side face 8b. In this case, unevenness of the contact of the pressing member 133 and the second side face 8b can be reduced, thereby performing the positional adjustment with higher accuracy. It is noted that, in FIGS. 5A and 5B, the pressing face 133b is held in line contact with the second side face 8b in the ±Z directions but may be held in line contact with the second side face 8b in the ±Y directions. Like the head position adjusting mechanism 130, a pressing face 143b of a pressing member 143 of a head position adjusting mechanism 140 which adjusts the position of the ink-jet head 2 in the ±Y directions may also have a curved face which is held in line contact with the fourth side face 8d.

Further, as shown in FIGS. 5C and 5D, a pressing face 233b of a pressing member 233 of a head position adjusting mechanism 230 which adjusts the position of the ink-jet head 2 in the ±X directions may have a spherical face which is held in point contact with the second side face 8b. Also in this case, unevenness of the contact of the pressing member 233 and the second side face 8b can be reduced, thereby performing the positional adjustment with higher accuracy. Like the head position adjusting mechanism 230, a pressing face 243b of a pressing member 243 of a head position adjusting mechanism 240 which adjusts the position of the ink-jet head 2 in the ±Y directions may also have a spherical face which is held in point contact with the fourth side face 8d.

Further, in the above-described embodiment, the first engaging mechanism 35 includes the slit 33c formed in the first pressing member 33 and the pin 32c provided on the first position adjusting member 32, but the first engaging mechanism 35 may be configured to include a pin provided on the first pressing member 33 and a slit formed in the first position adjusting member 32. Also in this case, the slit in the first position adjusting member 32 is formed so as to extend in parallel with the first inclined face 32a.

Further, the first engaging mechanism 35 includes the slit 33c formed in the first pressing member 33 and the pin 32c provided on the first position adjusting member 32, but the first engaging mechanism 35 may be configured to include (a) a projecting portion provided on one of the first position adjusting member 32 and the first pressing member 33 and (b) a depressing portion formed in the other thereof, with the projecting portion being fitted into the depressing portion.

Further, the adjusting mechanism 34 includes the thread hole 32b formed in the first position adjusting member 32 and the bolt 36 having the thread 36a engaged with the thread hole 32b, but may be configured to include a nut in which is provided an internal thread instead of the bolt 36, while an external thread is provided in the first position adjusting member 32. Also in this case, the movement of the nut in the ±Z directions is restricted. Further, a mechanism other than a mechanism using the thread may be employed as the adjusting mechanism.

Further, in the above-described embodiment, the plate spring 31 biases or forces the first side face 8a of the plate 8, and the first pressing member 33 presses the second side face 8b of the plate 8, but this ink-jet printer 1 may be configured such that members respectively for supporting the plate spring 31 and the first pressing member 33 are further provided, and the plate spring 31 forces a first side face of the frame 7 for supporting the four ink-jet heads 2 while the first pressing member 33 presses a second side face of the frame 7, thereby adjusting a position of the frame 7 in the ±X directions. Likewise, this ink-jet printer 1 may be configured such that members respectively for supporting the plate spring 41, the plate spring 71, and the second pressing member 43 are further provided, and the plate spring 41 and the plate spring 71 force a third side face of the frame 7 while the second pressing member 43 presses a fourth side face of the frame 7, thereby adjusting the position of the frame 7 in the ±θ directions.

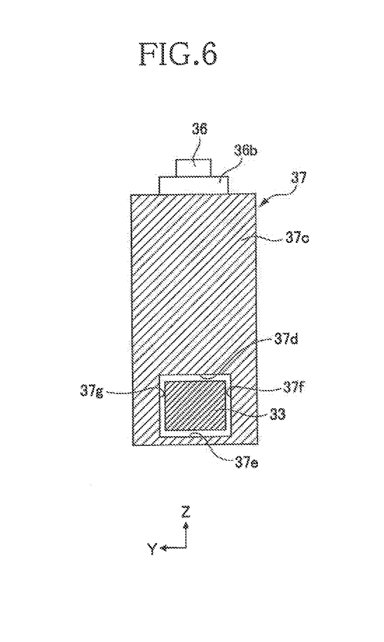

It is noted that, in the ink-jet printer 1 as the above-described embodiment, since the first inclined face 32a and the contacting face 33a are parallel to the Y axis, the first pressing member 33 is not moved in the ±Y directions when the first position adjusting member 32 is moved in the ±Z directions. However, the present invention is not limited to this configuration. For example, where each of the first inclined face 32a and the contacting face 33a is formed to be a face not parallel to the Y axis, the first pressing member 33 may be moved in the ±Y directions in addition to the ±X directions when the first position adjusting member 32 is moved in the ±Z directions. In this case, in order to restrict the movement of the first pressing member 33 in the ±Y directions, the ink-jet printer 1 may be configured as shown in FIG. 6 such that a right end portion 37f which restricts the movement of the first pressing member 33 in the −Y direction and a left end portion 37g which restricts the movement of the first pressing member 33 in the −Y direction are provided on the first restricting member 37. FIG. 6 is a cross-sectional view of the first restricting member 37 taken along a plane included in the side face 37c. In this construction, a flat face inclined with respect to the ±X directions, that is, any face which is not vertical or parallel to the ±X directions may be employed as the first inclined face 32a and the contacting face 33a.

Further, in the above-described embodiment, the ink-jet printer 1 includes the first engaging mechanism 35, but the present invention is not limited to this configuration. For example, the ink-jet printer 1 may not include the first engaging mechanism 35. Where the ink-jet printer 1 is thus configured, respective constructions of the first position adjusting member 32 and the first pressing member 33 are simplified, and a process for assembling the head position adjusting mechanism 30 is also simplified.

The ink-jet recording apparatus to which the present invention is applied is not limited to the ink-jet type but may be applied to a thermal type apparatus. Further, this ink-jet recording apparatus is not limited to the line type but may be applied to a serial type apparatus in which heads reciprocate. Further, this ink-jet recording apparatus is not limited to the printer but may be applied to other apparatuses such as a facsimile machine and a copier machine. Further, the sheet-feed mechanism 50 in the present embodiment feeds the sheet P in a horizontal direction, but this ink-jet recording apparatus may be configured such that the sheet-feed surface 54 which is parallel to the ink-ejection surfaces 2a is disposed so as to be inclined with respect to the horizontal direction such that the sheet P is allowed to be fed in a direction different from the horizontal direction such as a slanting direction and a vertical direction.

What is claimed is:

1. An ink-jet recording apparatus including a position adjusting mechanism of a recording head supported by a support member, the ink-jet recording apparatus comprising:
a first force applying member configured to apply a force, in a first direction extending along the recording surface, to a first side face which is one of a plurality of side faces of the recording head having a recording surface that faces a recording medium upon forming an image on the recording medium, the first side face intersecting the recording surface;
a first position adjusting member supported by the support member and configured to hold the recording head by receiving the force in the first direction which is applied to the first side face by the first force applying member, the first position adjusting member having, at a portion thereof which receives the force in the first direction, a first inclined face inclined with respect to the first direction;
a first pressing member disposed between the first inclined face and a second side face which is one of the plurality of side faces that is opposed to the first side face, the first pressing member having (i) a second inclined face which is an inclined face parallel to the first inclined face and which contacts the first inclined face and (ii) a pressing face which presses the second side face; and
a first moving mechanism configured to move the first position adjusting member relative to the first pressing member in a direction along a second direction intersecting both of the first direction and an in-plane direction of the first inclined face,
wherein the first moving mechanism includes:
a first thread member provided on the first position adjusting member;
a second thread member engaged with the first thread member; and
a limiting member configured to limit a movement of the second thread member in the direction along the second direction.

2. The ink-jet recording apparatus according to claim 1,
wherein the second thread member is supported by the limiting member so as to be rotatable about an axis extending along the second direction.

3. The ink-jet recording apparatus according to claim 1,
wherein the limiting member comprises an end portion to which rotational force for rotation of the second thread member is applied.

4. The ink-jet recording apparatus according to claim 1,
wherein the position adjusting mechanism further includes a first engaging mechanism configured to engage the first position adjusting member and the first pressing member with each other such that the second inclined face is held in contact with the first inclined face when the first position adjusting member is moved in the direction along the second direction.

5. The ink-jet recording apparatus according to claim 1,
wherein the position adjusting mechanism further includes a first restricting member supported by the support member and configured to restrict a moving direction of the first pressing member substantially only to a direction along the first direction when the first position adjusting member is moved relative to the first pressing member in the direction along the second direction.

6. The ink-jet recording apparatus according to claim 1,
wherein the first restricting member includes a second-direction restricting portion configured to restrict the movement of the first pressing member in the direction along the second direction such that the first pressing member is not moved substantially in the direction along the second direction when the first position adjusting member is moved in the direction along the second direction.

7. The ink-jet recording apparatus according to claim 6,
wherein the second-direction restricting portion includes (i) a first contact portion configured to be capable of contacting one of end portions of the first pressing member in the second direction and (ii) a second contact portion configured to be capable of contacting the other of the end portions of the first pressing member in the second direction, and
wherein a distance between the first contact portion and the second contact portion in the second direction is larger than a width of the first pressing member in the second direction.

8. The ink-jet recording apparatus according to claim 5,
wherein the first moving mechanism is configured to convert a rotational operation given to the first moving mechanism to a moving operation of the position adjusting mechanism in the direction along the second direction.

9. The ink-jet recording apparatus according to claim 8,
wherein the first restricting member is configured to restrict the movement of the first position adjusting member such that the first position adjusting member is not rotated by the rotational operation given to the first moving mechanism.

10. The ink-jet recording apparatus according to claim 5,
wherein the first restricting member has an opening portion which permits the movement of the first position adjusting member in the direction along the second direction across an end portion of the first restricting member in the second direction.

11. The ink-jet recording apparatus according to claim 1,
wherein the position adjusting mechanism further includes:
a second force applying member configured to apply a force to a third side face as one of the plurality of side faces which intersects the first side face and the second side face and which has a length larger in a direction along the recording surface than that of the first side face, and configured to apply a force in a third direction extending along the recording surface and perpendicular to the first direction at a first-side-face-side portion and a second-side-face-side portion of the third side face, the first-side-face-side portion being nearer to the first side face and the second-side-face-side portion being nearer to the second side face than the first-side-face-side portion;
a fixed reference member fixed to the support member and configured to support a fourth side face at a position thereof corresponding to the first-side-face-side portion, the fourth side face being one of the plurality of side faces which intersects the first side face and the second side face and which is opposed to the third side face; and
a third direction adjusting mechanism configured to adjust a position of a second-side-face near contact portion of the fourth side face in a direction along the third direction by contacting the second-side-face near contact portion which corresponds to the second-side-face-side portion.

12. The ink-jet recording apparatus according to claim 11,
wherein the third direction adjusting mechanism includes:
a second position adjusting member supported by the support member and configured to hold the recording head by receiving a force in the third direction which is applied to the third side face by the second force applying member, the second position adjusting member having, at a portion thereof which receives the force in the third direction, a third inclined face inclined with respect to the third direction;
a second pressing member having a fourth inclined face which is an inclined face parallel to the third inclined face and which contacts the third inclined face and disposed such that the fourth inclined face is held in contact with the third inclined face; and
a second moving mechanism configured to move the second position adjusting member relative to the second pressing member in a direction extending along a fourth direction which intersects both of the third direction and an in-plane direction of the third inclined face.

13. The ink-jet recording apparatus according to claim 12,
wherein the third direction adjusting mechanism further includes a second engaging mechanism configured to engage the second position adjusting member and the second pressing member with each other such that the fourth inclined face is held in contact with the third inclined face when the second position adjusting member is moved in the direction along the fourth direction.

14. The ink-jet recording apparatus according to claim 12,
wherein the third direction adjusting mechanism further includes a second restricting member supported by the support member and configured to restrict a moving direction of the second pressing member substantially only to the direction along the third direction when the second position adjusting member is moved relative to the second pressing member in the direction along the fourth direction.

15. The ink-jet recording apparatus according to claim 4,
wherein the first engaging mechanism includes:
a slit formed in one of the first pressing member and the first position adjusting member so as to extend in parallel with the first inclined face; and
a pin provided on the other of the first pressing member and the first position adjusting member so as to be moved in the slit in parallel with the first inclined face.

16. The ink-jet recording apparatus according to claim 1,
wherein the pressing face of the first pressing member has a flat face which is held in surface contact with the second side face.

17. The ink-jet recording apparatus according to claim 1,
wherein the pressing face of the first pressing member has a curved face which is held in line contact with the second side face.

18. The ink-jet recording apparatus according to claim 1,
wherein the pressing face of the first pressing member has a spherical face which is held in point contact with the second side face.
